(19) United States
(12) Patent Application Publication
(10) Pub. No.: US 2007/0109453 A1
(43) Pub. Date: May 17, 2007

(54) Electro-optical apparatus and electronic apparatus

(75) Inventors: Hideki Kaneko, Tottori-shi (JP); Satoshi Morita, Tottori-shi (JP); Hiroki Sugiyama, Tottori-shi (JP); Takao Atarashiya, Tottori-shi (JP)

Correspondence Address: OLIFF & BERRIDGE, PLC, P.O. BOX 19928, ALEXANDRIA, VA, 22320, US

(73) Assignee: SANYO EPSON IMAGING DEVICES CORPORATION, Tokyo (JP)

(21) Appl. No.: 11/543,114

(22) Filed: Oct. 5, 2006

(30) Foreign Application Priority Data
Nov. 16, 2005 (JP) 2005-331389

(51) Int. Cl. G02F 1/1343

(52) U.S. Cl. 349/38

(57) ABSTRACT

An electro-optical apparatus includes: a plurality of pixels, each pixel including four subpixels or more; a gate-insulating layer having a two-layered structure; and auxiliary capacitance formed in one of the layers of the gate-insulating layer.

### BACKGROUND

1. Technical Field

The present invention relates to an electro-optical apparatus suitably used to display various types of information.

2. Related Art

In the related art, various electro-optical apparatuses such as liquid crystal apparatuses, organic electroluminescence display apparatuses, plasma display apparatuses, and field emission display apparatuses are known.

In general, the liquid crystal apparatus as an example of an electro-optical apparatus includes a substrate on which pixel electrodes and the like are disposed, an opposite substrate on which a common electrode is disposed, and a liquid crystal layer interposed therebetween.

In an active matrix driving-type liquid crystal apparatus having thin-film transistors (hereinafter, referred to as TFT devices), a plurality of pixel electrodes are arrayed in a matrix in an effective display region for displaying an image. In such a liquid crystal apparatus, in order to display the image, image signals are sequentially applied to pixel electrode groups included in pixel electrode rows. Hereinafter, the procedure is called a “scan.” In the scan, at a timing corresponding to a pixel electrode group included in an arbitrary row, voltages as image signals are applied to all the pixel electrodes included in the pixel electrode row, and a potential difference across the common electrode and the pixel electrode group included in the pixel electrode row is sustained until the next scan is performed on the pixel electrode group included in the pixel electrode row. In general, the electric capacitance of a liquid crystal between the pixel electrode and the common electrode (sometimes, referred to as liquid crystal capacitance denoted by Clc) is not sufficient. Therefore, in order to enhance charge storage of the pixel electrode, auxiliary capacitance (generally, denoted by Cs) is provided to the pixel electrode. As a method of forming the auxiliary capacitance, a method of overlapping a portion of the pixel electrode with other wire lines through an insulating film or other dielectric members in a plan view has been proposed. An example of an active matrix driving-type liquid crystal apparatus having such an auxiliary capacitance is disclosed in JP-A-2005-157218.

In such a color display liquid crystal apparatus, colored layers corresponding to primary colors of red R, green G, and blue B are disposed on pixel electrodes. In such a liquid crystal apparatus, voltages are applied to the pixel electrodes corresponding to the colors according to grayscales, and the transmittances of the pixel electrodes are adjusted, so that detailed intermediate colors can be displayed. Recently, an image display apparatus has been proposed where, in addition to subpixels corresponding to the three primary colors R, G, B, a subpixel corresponding to a complementary color of cyan C is provided, so that an image can be displayed in a wider color range (for example, see JP-A-2001-306023)

However, in the aforementioned liquid crystal apparatus, a large number of auxiliary capacitors are disposed in order to prevent crosstalk, flicker, or the like. According to recent development of compact, highly-fine liquid crystal apparatuses, the sizes of subpixels are markedly reduced. Therefore, when the aspect ratios of the subpixels are considered, it is not easy to increase the sizes of the auxiliary capacitance portions with a large number of auxiliary capacitors maintained. Particularly, in a case where one pixel electrode is constructed with four color subpixels, since the sizes of the subpixels are further reduced, the problem becomes more dominant.

### SUMMARY

An advantage of some aspects of the invention is that it is provide an electro-optical apparatus of displaying four colors capable of maintaining a predetermined size of an auxiliary capacitance and improving an aspect ratio and electronic apparatus including the electro-optical apparatus.

According to an aspect of the invention, there is provided an electro-optical apparatus comprising: a plurality of pixels, each pixel including four subpixels or more; a gate-insulating layer having a two-layered structure; and auxiliary capacitance formed in one of the layers of the gate-insulating layer.

In the aforementioned electro-optical apparatus, one pixel includes four subpixels or more, and a gate-insulating layer has a two-layered structure. In the aforementioned electro-optical apparatus, auxiliary capacitance is disposed on one of the layers in the two-layered structure of the gate-insulating layer. Therefore, in a method of manufacturing the electro-optical apparatus, a thickness of one layer in the gate-insulating layer in which the auxiliary capacitance is formed can be set to be smaller than that of the other layer in the gate-insulating layer. Since one of the layers in the two-layered structure of the gate-insulating layer can formed to be thin, it is possible to increase auxiliary capacitance. Therefore, it is possible to reduce a area of a portion where the auxiliary capacitance is formed and to maintain a predetermined magnitude of the auxiliary capacitance. Accordingly, it is possible to improve an aspect ratio of each subpixel.

According to an aspect of the invention, there is provided an electro-optical apparatus comprising: a plurality of pixels, each pixel including four subpixels or more; first and second wire lines which extend to intersect each other; auxiliary capacitance lines disposed between two adjacent second wire lines; thin-film transistors which are disposed at positions corresponding to intersections of the first and second wire lines, each thin-film transistor including a gate electrode portion constituted by a portion of the second wire line, a first insulating layer disposed on the gate electrode portion and constituted by the gate-insulating layer, a second insulating layer disposed on the first insulating layer, having a smaller thickness than the first insulating layer, and constituted by the gate-insulating layer, a drain electrode portion disposed on the second insulating layer, and a source electrode portion disposed on the second insulating layer and constituted by a portion of the first wire line; a substrate having pixel electrodes electrically connected to the drain electrode portions; and auxiliary capacitance portions disposed at positions where the auxiliary capacitance lines and the pixels overlaps each other in a plan view to form auxiliary capacitance, wherein each of the auxiliary capacitance portions includes an auxiliary capacitance electrode portion constituted by a portion of the auxiliary capacitance line, the second insulating layer disposed on the auxiliary capacitance electrode portion, and the drain electrode portion disposed on the second insulating layer, and wherein at least a portion of the auxiliary capacitance portion does not overlap the first insulating layer.

The aforementioned electro-optical apparatus may include a plurality of pixels, each pixel including four subpixels or more; first and second wire lines which extend to intersect each other; auxiliary capacitance lines disposed between two adjacent second wire lines; thin-film transistors which are disposed at positions corresponding to intersections of the first and second wire lines, each thin-film transistor including a gate electrode portion constituted by a portion of the second wire line, a first insulating layer disposed on the gate electrode portion and constituted by the gate-insulating layer, a second insulating layer disposed on the first insulating layer, having a smaller thickness than the first insulating layer, and constituted by the gate-insulating layer, a drain electrode portion disposed on the second insulating layer, and a source electrode portion disposed on the second insulating layer and constituted by a portion of the first wire line; and a substrate having pixel electrodes electrically connected to the drain electrode portions.

As a preferred example, source lines through which image signals are output or gate lines through which gate signals are output may be used as the first wire lines, and the associated gate or source lines may be used as the second wire lines.

Particularly, in the electro-optical apparatus, the auxiliary capacitance portions may be disposed at positions where the auxiliary capacitance lines and the pixels overlaps each other in a plan view to form auxiliary capacitance, each of the auxiliary capacitance portions includes an auxiliary capacitance electrode portion constituted by a portion of the auxiliary capacitance line, the second insulating layer disposed on the auxiliary capacitance electrode portion, and the drain electrode portion disposed on the second insulating layer, and at least a portion of the auxiliary capacitance portion may not overlap the first insulating layer. As a preferred example, the thickness of the first insulating layer may be in the range of 2000 Å to 4000 Å, and the thickness of the second insulating layer may be in the range of 500 Å to 1500 Å.

Therefore, in the auxiliary capacitance portion, the auxiliary capacitance using the second insulating layer as a dielectric material is formed between the drain electrode portion and the auxiliary capacitance portion. As described above, since the thickness of the second insulating layer is set to be smaller than that of the first insulating layer, it is possible to reduce a size “d” in a general electrostatic capacitance equation: C=(εᵣ×ε₀×S)/d. In the equation, C is the auxiliary capacitance, εᵣ is a specific dielectric constant of the second insulating layer constituting the auxiliary capacitance portions, ε₀ is the dielectric constant of vacuum, S is a area of the auxiliary capacitance portions, and d is a thickness of the second insulating layer.

Therefore, in the auxiliary capacitance portion, the auxiliary capacitance C can be increased by a decrease in the thickness d of the second gate-insulating film in the equation. As a result, it is possible to reduce the area S of the auxiliary capacitance portion and maintain a predetermined magnitude of the auxiliary capacitance C in the equation, so that it is possible to improve the aspect ratio.

In the aforementioned electro-optical apparatus, an interlayer insulating film may be disposed between the pixel electrode and the drain electrode portion, a contact hole is disposed at a portion of the interlayer insulating film where the auxiliary capacitance portion is located, and the pixel electrode may be electrically connected to the drain electrode portion through the contact hole. As a preferred example, the auxiliary capacitance lines may be made of a conductive material having a light-shielding property.

In this case, an interlayer insulating film made of, for example, a transparent insulating resin material may be disposed between the pixel electrode and the drain electrode portion, a contact hole is disposed at a portion of the interlayer insulating film where the auxiliary capacitance portion is located, and the pixel electrode may be electrically connected to the drain electrode portion through the contact hole. Since the auxiliary capacitance portion is made of a conductive material having a light-shielding property, the auxiliary capacitance portion also has a light-shielding property. Therefore, although disclination (abnormal alignment of liquid crystal molecules) occurs at positions of the contact holes due to shapes of the contact holes, the disclination can be covered and hidden by the auxiliary capacitance portion having a light-shielding property. Accordingly, it is possible to prevent deterioration in display quality at the positions of the contact holes.

In the aforementioned electro-optical apparatus, each of the subpixels may have a transmitting region, a reflecting region, or both transmitting and reflecting regions, a reflecting film is disposed at a position corresponding to the reflecting region, and the pixel electrode may be provided to each of the subpixels.

In this case, each of the subpixels has a transmitting region, a reflecting region, or both transmitting and reflecting regions. In addition, a reflecting film is disposed at a position corresponding to the reflecting region, and each of the pixels includes four subpixels. Therefore, it is possible to implement a transmissive electro-optical apparatus, a reflective electro-optical apparatus, and a semi-transmissive semi-reflective electro-optical apparatus. Particularly, in this case, since one pixel includes four subpixels or more, the aspect ratio may be deteriorated in comparison with a case where one pixel includes three subpixels. However, since the aforementioned electro-optical apparatus is constructed with a construction according to the invention, it is possible to prevent a deterioration in the aspect ratio of each subpixel.

In the aforementioned electro-optical apparatus, the auxiliary capacitance portion is provided in the reflecting region, wherein the reflecting film is disposed on the interlayer insulating film, and wherein the auxiliary capacitance portion and the reflecting film overlap each other in a plan view. Therefore, since the auxiliary capacitance portion 72 is not a non-display region but used as a reflective display region, it is possible to improve the aspect ratio. In addition, in this case, since the reflecting region can be arranged according to the size of the auxiliary capacitance portion, the area of the reflecting region is set to be small, and the area of the transmitting region is set to be large, so that the transmissive display mode is constructed to be dominated.

The aforementioned electro-optical apparatus may further comprise a substrate which includes an electro-optical layer having negative dielectric anisotropy, wherein the pixel electrode includes a plurality of polygonal or circular unit electrode portions, and wherein colored regions which are in a visible range in which the color of light varies with wavelength and which are provided to positions corresponding to the subpixels include a blue-based region, a red-based region, and two colored regions of which colors are selected from the color range of blue to yellow.

In this case, the substrate includes an electro-optical layer having negative dielectric anisotropy. Therefore, it is possible to implement a vertically aligned type electro-optical apparatus. In addition, since the pixel electrode includes a plurality of polygonal or circular unit electrode portions, the liquid crystal molecules constituting an electro-optical layer can be aligned in a radial shape on the unit electrode portions. Therefore, a dependency on a viewing angle is suppressed, so that it is possible to obtain a wide viewing angle. In particular, even in a case where the aspect ratio may be reduced due to small area of the pixel electrode, the area of the auxiliary capacitance portion can be reduced by employing the invention, so that it is possible to greatly improve the aspect ratio.

In addition, the colored regions which are in a visible range in which the color of light varies with wavelength and which are provided to positions corresponding to the subpixels include a blue-based region, a red-based region, and two colored regions of which colors are selected from the color range of blue to yellow. Therefore, in comparison with an electro-optical apparatus using three colors R, G, and B, a color reproducible range (chromaticity range) can be widened, so that it is possible to implement a high color rendering display.

In the aforementioned electro-optical apparatus, in a CIE chromaticity diagram, the blue-based region may be a colored region satisfying the relation of x≦0.151 and y≦0.200, the red-based region may be a colored region satisfying the relation of 0.520≦x and y≦0.360, the one of the two colored regions of which colors are selected from the color range of blue to yellow may be a colored region satisfying the relation of x≦0.200 and 0.210≦y, and the other colored region may be a colored region satisfying the relation of 0.257≦x and 0.450≦y.

In the aforementioned electro-optical apparatus, the colored region which are provided to positions corresponding to the subpixels include a first colored region of which the peak wavelength of light passing through the first color region may be in the range of 415 nm to 500 nm, a second colored region of which the peak wavelength of light passing through the second color region may be 600 nm or more, a third colored region of which the peak wavelength of light passing through the third color region may be in the range of 485 nm to 535 nm, and a fourth colored region of which the peak wavelength of light passing through the fourth color region may be in the range of 500 nm to 590 nm.

According to still another aspect of the invention, there is provided an electronic apparatus having any one of the aforementioned electro-optical apparatuses.

### BRIEF DESCRIPTION OF THE DRAWINGS

The invention will be described with reference to the accompanying drawings, wherein like numbers reference like elements.

FIG. 1 is schematic plan view showing a construction of a liquid crystal apparatus according to a first embodiment of the invention;

FIG. 2 is an equivalent circuit diagram of the liquid crystal apparatus according to the first embodiment;

FIG. 3 is a plan view showing a construction of a pixel according to the first embodiment;

FIG. 4 is a partial cross-sectional view taken along line IV-IV of FIG. 3;

FIGS. 5A and 5B are plan view showing constructions of various types of pixels for explaining a method of increasing an aspect ratio of pixel according to the invention;

FIGS. 6A and 6B are partial cross-sectional views showing constructions of auxiliary capacitance portions according to the first embodiment and a comparative example;

FIG. 7 is a partial cross-sectional view showing a construction of a pixel according to a second embodiment;

FIG. 8 is a partial cross-sectional view taken along line VIII-VIII of FIG. 7;

FIGS. 9A and 9B are plan views showing constructions of various types of pixels according to modified examples; and

FIGS. 10A and 10B are views showing examples of an electronic apparatus using the liquid crystal apparatus according to the invention.

### DESCRIPTION OF EXEMPLARY EMBODIMENTS

Hereinafter, preferred embodiments of the invention are described with reference to the accompanying drawings. The later-described embodiments employ a liquid crystal apparatus according to the invention.

### First Embodiment

The first embodiment of the invention employs a transmissive liquid crystal apparatus having TN (Twisted Nematic) liquid crystals and pixels, each of which includes four-colored regions. The four-colored regions are a red (R) colored region, a green (G) colored region, a blue (B) colored region, and a cyan (C) colored region. The invention is not limited thereto, thus more than four colored regions may be provided.

Construction of Liquid Crystal Apparatus

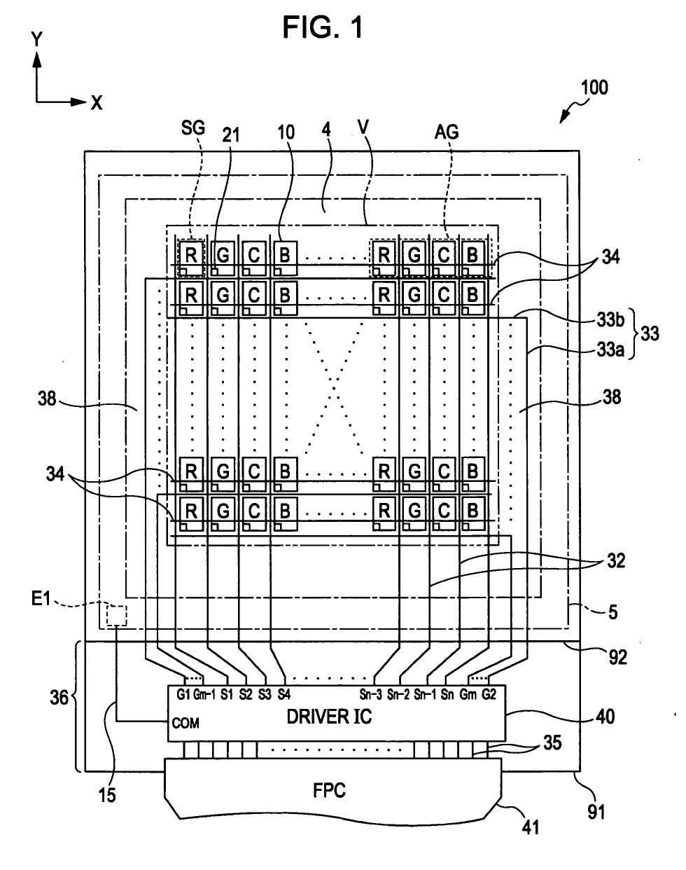

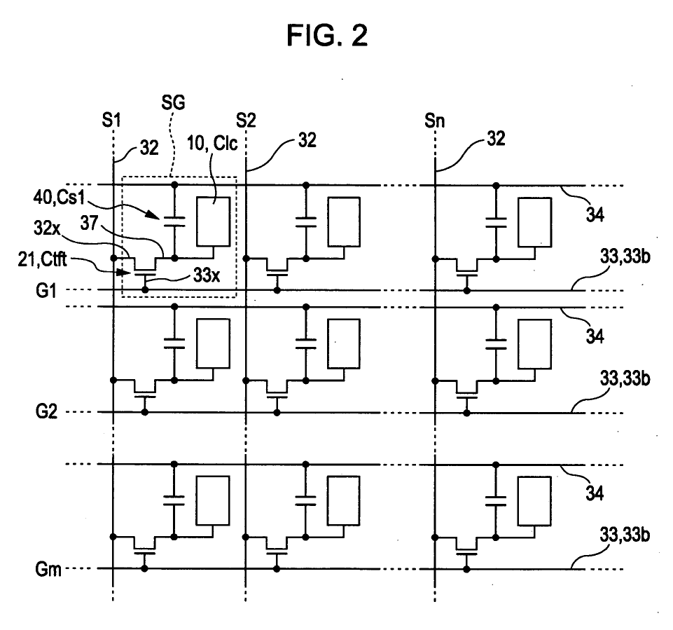

Firstly, a construction of a liquid crystal apparatus 100 according to the first embodiment of the invention is described with reference to FIGS. 1 and 2.

FIG. 1 is a schematic plan view showing the construction of the liquid crystal apparatus 100 according to the first embodiment of the invention. In FIG. 1, a color filter 92 is disposed at the front side (observer's side) of the paper, and a device substrate 91 is disposed at the rear side of the paper. In addition, in FIG. 1, the longitudinal and transverse directions of the paper are defined as the Y and X directions, respectively. Moreover, in FIG. 1, a region corresponding to one of the four colored layers (not shown) represents one subpixel region SG, and a one-row four-column pixel array including the four subpixel regions SG represents one pixel region AG. Hereinafter, a single display region corresponding to one subpixel region SG is referred to as a “subpixel,” and a display region corresponding to one pixel region AG is referred to as a “pixel.”

The liquid crystal apparatus 100 is constructed by attaching the device substrate 91 and the color filter substrate 92 which are disposed so as to face each other with a frame-shaped sealing member 5 interposed therebetween and forming a liquid crystal layer 4 by sealing, for example, TN liquid crystals inside the area denoted by the sealing member 5.

The liquid crystal apparatus 100 is a color display liquid crystal apparatus constructed by using a plurality of the colored layers 6 corresponding to four colored regions and an active matrix driving-type liquid crystal apparatus using α-Si TFT devices 21 as switching devices. In addition, the liquid crystal apparatus 100 is a transmissive liquid crystal apparatus performing only a transmissive display mode.

Firstly, a planar construction of the device substrate 91 is described. A plurality of source lines 32, a plurality of gate lines 33, a plurality of auxiliary capacitance lines 34, a plurality of the α-Si TFT devices 21, a plurality of pixel electrodes 10, a driver IC 40, external connection wire lines 35, an FPC (Flexible Printed Circuit) 41, and the like are mainly disposed or mounted on an inner surface of the device substrate 91.

As shown in FIG. 1, the device substrate 91 has a protruding region 36 which is formed so as to protrude over one edge of the color filter substrate 92 outwardly, and the driver IC 40 is mounted on the protruding region 36. Each input terminal (not shown) of the driver IC 40 are electrically connected to one end of each of the external connection wire lines 35. The other end of each of the external connection wire lines 35 is electrically connected to the FPC 41. A side of the FPC 41 is connected to an electronic apparatus (not shown).

The source lines 32 are disposed to extend in the Y direction with a predetermined X-directional interval. The one end of each of the source lines 32 is electrically connected to a corresponding output terminal (not shown) of the driver IC 40.

Each of the gate lines 33 includes a first wire line 33a which is disposed to extend in the Y direction and a second wire line 33b which is disposed to extend from the end portions of the first wire lines 33a in the X direction within an effective display region V. The second wire lines 33b of the gate lines 33 are disposed to extend in a direction intersecting the source lines 32 with a predetermined Y-directional interval. The one end of each of the first wire lines 33a of the gate lines 33 is electrically connected to a corresponding output terminal (not shown) of the driver IC 40.

The auxiliary capacitance lines 34 are made of a conductive material having a light-shielding property. The auxiliary capacitance lines 34 are disposed to extend in the same direction as those of the second wire lines 33b of the gate lines 33 and to be interposed between the second wire lines 33b of the gate lines 33 which are adjacent to each other in the Y direction.

The α-Si TFT devices 21 are disposed at positions corresponding to the intersections of the source lines 32 and the second wire lines 33b of the gate lines 33. The α-Si TFT devices 21 are electrically connected to the source lines 32, the gate lines 33, the pixel electrodes 10, and the like. The pixel electrodes 10 are disposed in the subpixel regions SG.

A region formed by arraying a plurality of the pixel regions AG in a matrix in the X and Y directions is the aforementioned effective display region V (a region surrounded by a two-dotted dashed line in the figure). An image including characters, numbers, symbols, and the like is displayed in the effective display region V. In addition, an outer region of the effective display region V is a frame region 38 which is not contributed to image display.

Next, a planar construction of the color filter substrate 92 is described. The color filter substrate 92 includes a light-shielding layer (generally, referred to as a black matrix and, hereinafter, simply denoted BM), a plurality of the colored layers 6 corresponding to the aforementioned four colored regions, a common electrode 8, and the like.

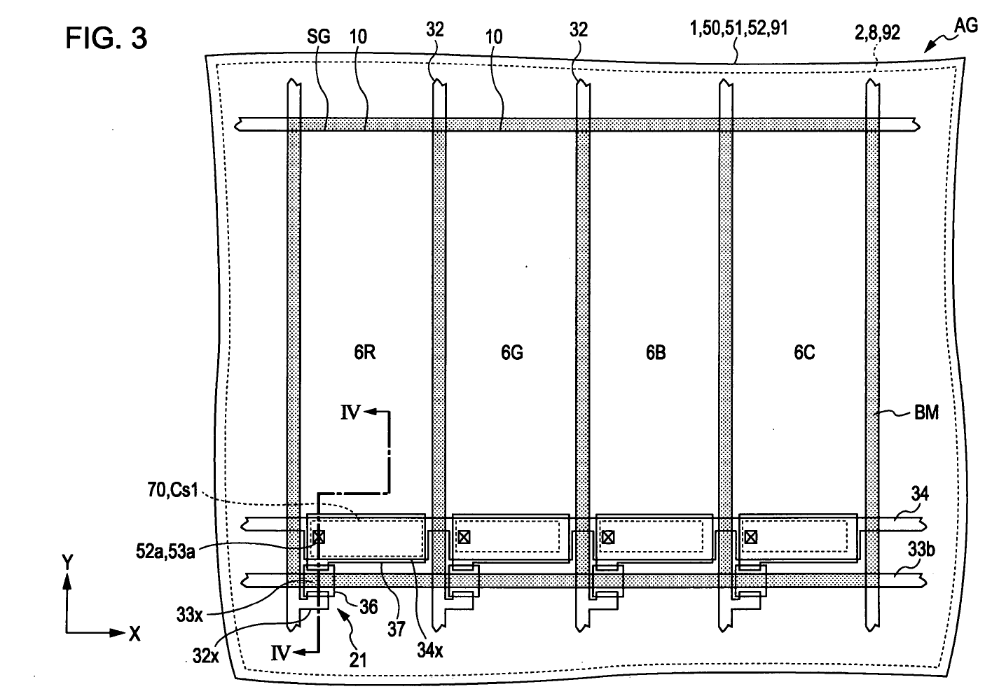

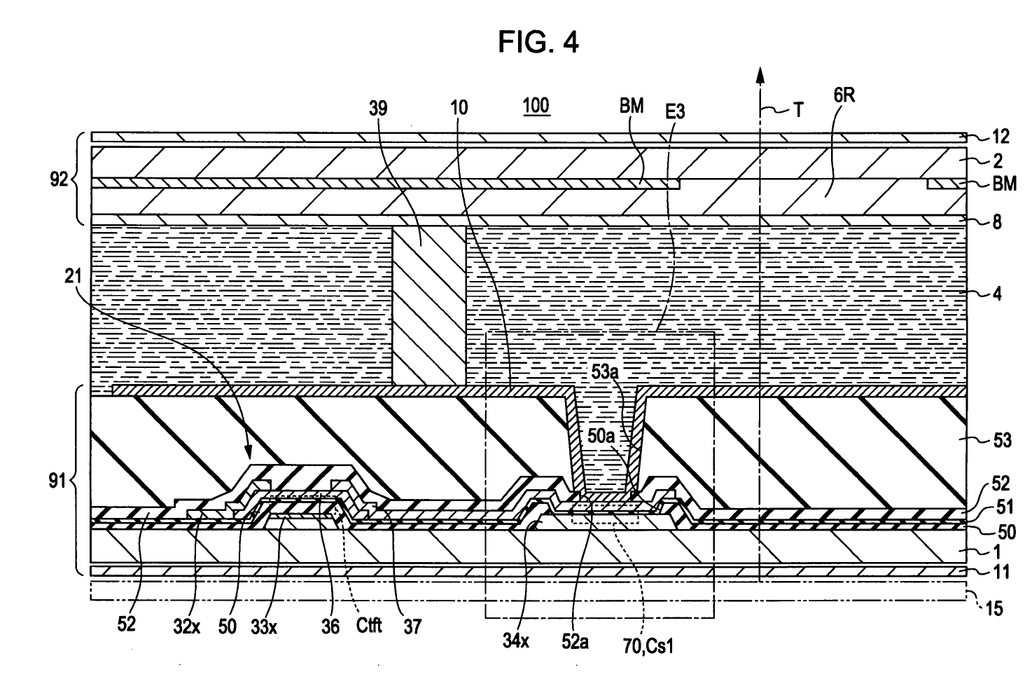

A plurality of the colored layers 6 corresponding to the four colored regions include a colored layer 6R having a red region, a colored layer 6G having a green region, a colored layer 6B having a blue region, and a cyan colored layer 6C having a cyan region. Hereinafter, a colored layer of which color is not specified is referred to a colored layer 6, and a colored layer of which color is specified is referred to a colored layer 6R, or the like. The BM is disposed among regions partitioning the subpixel regions SG and regions corresponding to the α-Si TFT devices 21 and the auxiliary capacitance portion 70 (see FIGS. 3 and 4). For the convenience of description, in FIG. 3, the portion (hatching) of the BM disposed in the regions corresponding toe the α-Si TFT devices 21 and the auxiliary capacitance lines 34 is omitted. Similar to the pixel electrodes, the common electrode 8 is made of a transparent material such as ITO and formed substantially over a surface within the area denoted by the sealing member 5. The common electrode 8 is electrically connected to ones-side end of a wire line 15 at a corner region E1 of the sealing member 5. The other end of the wire line 15 is electrically connected to an output terminal (ground terminal) corresponding to a terminal COM of the driver IC 40.

The liquid crystal apparatus 100 having such a construction is represented with an equivalent circuit diagram shown in FIG. 2. Next, operations of the liquid crystal apparatus 100 at the time of driving thereof are as follows.

Firstly, the source lines 32 for supplying image signals are connected to source electrodes 32x (see FIGS. 3 and 4) of the α-Si TFT devices 21, and the pixel electrodes are connected to drain electrodes 37 (see FIGS. 3 and 4) of the α-Si TFT devices 21. Gate electrodes 33x (see FIGS. 3 and 4) of the α-Si TFT devices 21 are connected to the gate lines 33. When the α-Si TFT devices 21, that is, switching devices are switched on for a predetermined time interval, the image signals S1, S2, . . . , and Sn supplied from the source lines 32 are written at predetermined timings. The image signals S1, S2, . . . , and Sn may be supplied in this order in a line sequence manner. Alternatively, the image signals S1, S2, . . . , and Sn may be supplied in units of a group of adjacent gate lines 32. Gate signals G1, G2, . . . , and Gm are applied to the gate lines 33 as pulse signals in this order in a line sequence manner.

The image signals S1, S2, . . . , and Sn having predetermined levels written in the liquid crystal layer 4 through the pixel electrode 10 are sustained for a predetermined time interval between the pixel electrodes 10 and the common electrode 8 (see FIG. 4) disposed on the color filter substrate 92. In order to prevent leakage of the sustained image signal, the auxiliary capacitance Cs1 of an auxiliary capacitance portion 70 (see FIGS. 3 and 4) including the aforementioned auxiliary capacitance line 34 and the like is added in parallel to the liquid crystal capacitance Clc formed between the pixel electrode 10 and the common electrode 8. In such a construction, due to the auxiliary capacitance Cs1 of the auxiliary capacitance portion 70, the voltage of the pixel electrode 10 can be sustained for a time interval by three orders of magnitude larger than a time interval when the source voltage is applied. Therefore, the sustaining characteristic of the liquid crystal apparatus 100 can be improved, so that contrast ratio can be improved. In the liquid crystal apparatus 100, the display state of the liquid crystal layer 4 is converted into a non-display state or an intermediate display state, so that an alignment state of liquid crystal molecules in the liquid crystal layer 4 can be controlled. Accordingly, it is possible to display a desired image in the effective display region V.

Construction of Pixel

Next, a construction of a pixel according to the first embodiment of the invention is described with reference to FIGS. 3 and 4.

FIG. 3 is a partial plan view showing one pixel of the liquid crystal apparatus 100 as seen from the color filter substrate 92 to the device substrate 91 in a plan view. FIG. 4 is a partial cross-sectional view showing one pixel of the liquid crystal apparatus 100 taken along line IV-IV of FIG. 3.

Firstly, a construction of the pixel in the device substrate 91 is described.

The second wire lines 33b of the gate lines 33 and the auxiliary capacitance lines 34 are disposed to extend in the X direction on the inner surface of a lower substrate 1. The second wire lines 33b of the gate lines 33 and the auxiliary capacitance lines 34 may be made of a conductive material having a light-shielding property such as aluminum, molybdenum, chromium, an alloy thereof, or other conductive materials. In the first embodiment, each of the gate lines 33 has a multi-layered structure made of the aforementioned conductive material. Since the wire lines including the gate lines 33 may peel off due to a change in temperature during manufacturing of the device substrate 91, the gate lines 33 are formed to have the multi-layered structure. The second wire lines 33b are disposed with a predetermined Y-directional interval. Each of the auxiliary capacitance lines 34 is disposed between the adjacent second wire lines 33b in the vicinity of one of the second wire lines 33b. A portion of each second wire line 33b becomes the gate electrode 33x and, together with other devices described later, constitutes one of the α-Si TFT devices 21. Each auxiliary capacitance line 34 includes an auxiliary capacitance electrode 34 formed by enlarging a width of a portion of the auxiliary capacitance line, which is provided to each subpixel.

A first gate-insulating film 50 made of a transparent resin material such as silicon nitride is disposed on the inner surface of the lower substrate 1, each second wire line 33b, and the like. The thickness of the first gate-insulating film 50 is dependent on the insulating property of the gate line 33 and the like. Therefore, the thickness is preferably in the range of 2000 Å to 4000 Å, and more preferably, 2800 Å or more. The first gate-insulating film 50 has an opening 50a at a position corresponding to the auxiliary capacitance electrode 34x. Therefore, the inner surface of the auxiliary capacitance electrode 34x is not provided with the first gate-insulating film 50 except for a portion thereof. A second gate-insulating film 51 is disposed on the inner surface of the auxiliary capacitance electrode 34x and the first gate-insulating film 50. The second gate-insulating film 51 may be made of the same material as that of the first gate-insulating film 50, that is, silicon nitride. Alternatively, the second gate-insulating film 51 may be made of other insulating materials, for example, silicon oxide. The thickness of the second gate-insulating film 51 is smaller than that of the first gate-insulating film 50, preferably in the range of 500 Å to 1500 Å, and more preferably, about 1000 Å, for example, in the range of 800 Å to 1200 Å.

As described above, since the second gate-insulating film 51 is disposed on the inner surface of the first gate-insulating film 50 and the like, each of the gate lines 33 including the gate electrodes 33x is covered with the first and second gate insulating films 51 and 52. On the other hand, the inner surface of the auxiliary capacitance electrode 34x is covered with only the second gate-insulating film 51.

An α-Si layer 36 constituting one of the α-Si TFT devices 21 is disposed having an island shape on the inner surface of each gate electrode 33x. The thickness of the α-Si layer 36 is preferably about 1800 Å. Each of the source lines 32 is disposed to extend in the Y direction between the subpixel regions SG on the inner surface of the second gate-insulating film 51. Each of the source lines 32 has a source electrode 32x which branches out to each of the α-Si layers 36. The source electrode 32x and the α-Si layer 36 partially overlap each other and are electrically connected to each other. A drain electrode made of the same material as that of, for example, the source line 32 is disposed on inner surfaces of the second gate-insulating film 51 located in the auxiliary capacitance portion 70, the α-Si layer 36, and the like. Therefore, one end of the drain electrode 37 is electrically connected to the α-Si layer 36. As a result, the α-Si TFT devices 21 are disposed at the intersections of the second wire lines 33b of the gate lines 33 and the source lines 32. Device capacitance Ctft using the first gate-insulating film 50 and the second gate-insulating film 51 as a dielectric material is formed between the α-Si layer 36 and the gate electrode 33x. On the other hand, the auxiliary capacitance Cs1 using the second gate-insulating film 51 as a dielectric material is formed between the auxiliary capacitance electrode 34x and the drain electrode 37. In the specification, a region where the auxiliary capacitance Cs1 is formed is referred to as an auxiliary capacitance portion 70.

A protective insulating film 52 made of, for example, an inorganic insulating material is disposed on the inner surfaces of the second gate-insulating film 51, the α-Si TFT device 21, and the drain electrode 37 which is overlapped with the auxiliary capacitance electrode 34x in a plan view. The protective insulating film 52 has a function of covering and protecting wire lines and electrodes. In addition, the protective insulating film 52 has a contact hole 52a at a position corresponding to the auxiliary capacitance electrode 34x. For this reason, the protective insulating film 52 is not provided on the inner surface of the drain electrode 37 at the position of the auxiliary capacitance electrode 34x. An interlayer insulating film 53 made of, for example, an organic material is disposed on the inner surface of the protective insulating film 52. The interlayer insulating film 53 has a contact hole 53a at a position corresponding to the auxiliary capacitance electrode 34x.

The pixel electrode 10 made of, for example, ITO (Indium Tin Oxide) is disposed at a position corresponding to the subpixel region SG on the inner surfaces of the interlayer insulating film 53 and the drain electrode 37 disposed at a position corresponding to the auxiliary capacitance electrode 34x. Therefore, the pixel electrode 10 is electrically connected to the drain electrode 37 located above the auxiliary capacitance electrode 34x through the contact holes 52a and 53a. In addition, in the liquid crystal apparatus 100, although disclination (abnormal alignment of liquid crystal molecules) occurs at the positions of the contact holes 52a and 53a due to the shapes of the contact holes 52a and 53a, the disclination can be covered and hidden by the auxiliary capacitance portion 70 having a light-shielding property. Accordingly, it is possible to prevent deterioration in display quality at the positions of the contact holes 52a and 53a. An alignment film (not shown) which has been subjected to a rubbing process is disposed on the inner surfaces of the interlayer insulating film 53, the pixel electrode 10, and the like. A polarizing plate 11 is disposed on the outer surface of the lower substrate 1. As a result, the pixel including the auxiliary capacitance portion 70 on the device substrate 91 according to the first embodiment is constructed. In addition, a backlight 15 is disposed as an illumination unit on the outer surface of the polarizing plate 11.

Next, a construction of the color filter substrate 92 corresponding to the aforementioned construction of the device substrate 91 is described.

The BM having a light-shielding property is disposed in regions partitioning the subs pixel regions SG and regions corresponding to the α-Si TFT devices 21 and the auxiliary capacitance portions 70 on the inner surface of an upper substrate 2. The colored layers 6R, 6G, 6B, and 6C for corresponding subpixel electrodes SG are disposed on the BM and the inner surface of the upper substrate 2. In one pixel, the colored layers 6 are arrayed in the array order of the colored layers 6R, 6G, 6B, and 6C. The common electrode 9 made of the same material as that of the pixel electrode 10 is disposed on the inner surfaces of the colored layers 6. An alignment film (not shown) which has been subjected to a rubbing process is disposed on the inner surface of the common electrode 8. A polarizing plate 12 is disposed on the outer surface of the upper substrate 2. As a result, the color filter substrate 92 according to the first embodiment corresponding to the construction of the pixel of the device substrate 91 is constructed.

In such a construction, the device substrate 91 and the color filter substrate 92 are disposed so as to face each other with the sealing member 5 (see FIG. 1) interposed therebetween, and the liquid crystal layer 4 is formed by sealing the TN liquid crystals between the two substrates. In the liquid crystal apparatus 100, spacers 39 are provided between the alignment film on the device substrate 91 and the alignment film on the color filter substrate 92 and between the α-Si TFT devices 21 and the auxiliary capacitance portions 70, so that the thickness of the liquid crystal layer 4 can be defined as a predetermined thickness.

In the transmissive display mode of the liquid crystal apparatus 100 having such a construction, the illumination light emitted from the backlight 15 propagates along a path T shown in FIG. 4 and passes through the pixel electrodes 10 and the colored layers 6R, 6G, 6B, and 6C to reach the observer. When the illumination light passes the colored layers 6R, 6G, 6B, and 6C, predetermined colors and brightnesses can be obtained. As a result, a desired color image can be seen by the observer. Particularly, since the liquid crystal apparatus 100 is constructed to use the complementary color C as well as the primary colors R, G, and B, it is possible to suppress a decrease in the brightness of green light G to which human eyes are highly sensitive. In addition, in terms of the later-described CIE (Commission Internationale de l' Eclairage) x-y chromaticity diagram, in comparison with a liquid crystal apparatus using three colors R, G, and B, the color reproducible range (chromaticity range) can be widened, so that it is possible to implement a high color rendering display.

Method of Improving Aspect Ratio

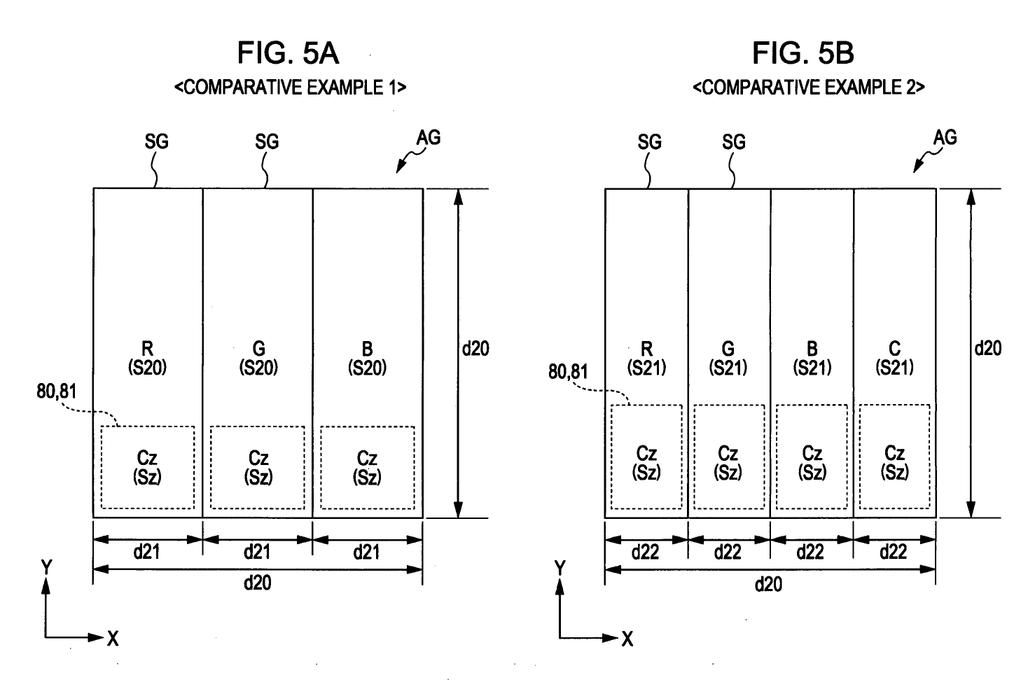

Firstly, a method of improving an aspect ratio of the subpixels according to the invention is described with reference to FIG. 5.

FIG. 5A is a view showing a construction of a general pixel (Comparative Example 1) using three colors R, G, and B and including three subpixels in one pixel. FIG. 5B is a view showing a construction of a pixel (Comparative Example 2) using four colors R, G, B, and C and including four subpixels in one pixel similar to that described in the first embodiment.

Since Comparative Example 2 uses the color C as well as the colors R, G, and B, Comparative Example 2 can implement a high color rendering display in comparison with Comparative Example 1. Comparative Example 2 has the following problems.

In a liquid crystal apparatus, the screen display resolution depends on the size of one pixel. In general, one pixel is formed to have a square shape of which the X-and Y-directional lengths are set to the same value d20. Therefore, in Comparative Example 1, the X-directional length d21 of each pixel corresponding to each color is set to d20/3. In Comparative Example 2, the X-directional length d22 of each pixel corresponding to each color is set to d20/4. In Comparative Example 1, an area S20 of one subpixel becomes d20×d21=d20×(d20/3). In Comparative Example 2, an area S21 of one subpixel becomes d20×d22=d20×(d20/4). Therefore, an area ratio of Comparative Example 1 to Comparative Example 2 becomes 4:3. Namely, in comparison with Comparative Example 1, the aspect ratio of Comparative Example 2 deceases with a decrease in the area of the subpixel.

In general, in an active matrix driving-type liquid crystal apparatus, auxiliary capacitance is provided in order to stabilize display quality. Similarly, in Comparative Examples 1 and 2, auxiliary capacitance portions 80 having predetermined area SZ and auxiliary capacitance SZ are provided in order to stabilize the display quality. In general, the auxiliary capacitance portions 80 are made of a conductive material having a light-shielding property. The auxiliary capacitance portions 80 become regions which are not contributed to image display. Since Comparative Example 2 uses the auxiliary capacitance portions 80 similarly to Comparative Example 1, Comparative Example 2 has a problem in that the aspect ratio is markedly decreased as the liquid crystal apparatus becomes increasingly thin.

According to the invention, in order to solve the problem, predetermined parameters of a general electrostatic capacitance equation are adjusted so as to improve the aspect ratio and maintain the magnitude of the auxiliary capacitance Cz of the auxiliary capacitance portion 80.

More specifically, the auxiliary capacitance Cz can be represented by Equation 1 according to the general electrostatic capacitance equation.
Cz=(εᵣ×ε₀×Sz)d . . . . (Equation 1)
In Equation 1, εᵣ is a specific dielectric constant of an insulating layer 81 constituted by the auxiliary capacitance portions 80, ε₀ is the dielectric constant of vacuum, Sz is the area of the auxiliary capacitance portions 80, and d is the thickness of the insulating layer 81.

Therefore, in Comparative Example 2, in order to improve the aspect ratio and maintain the magnitude of the auxiliary capacitance Cz, the thickness d of the insulating layer 81 is defined to be as small as possible under the state that the magnitude of the auxiliary capacitance Cz is maintained constant in Equation 1. Accordingly, the area occupied by the auxiliary capacitance portion 80 in the subpixel can be reduced, so that it is possible to improve the aspect ratio.

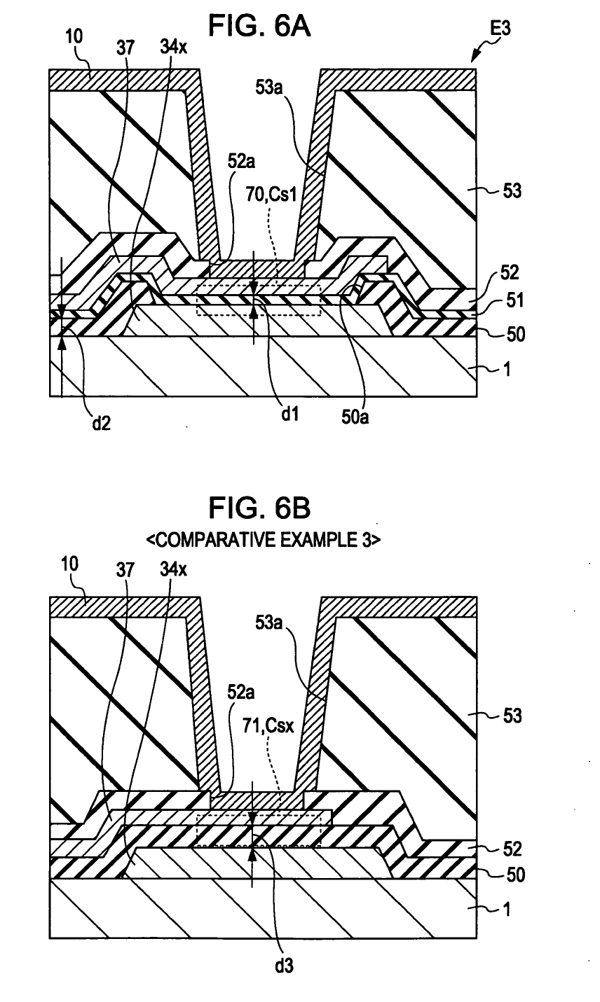

Now, a method of increasing the auxiliary capacitance according to the invention is described based on the above-described principle with reference to FIG. 6.

FIG. 6A is an enlarged cross-sectional view taken along a region E3 indicated by a broken line in FIG. 4. In particular, FIG. 6A is an enlarged cross-sectional view showing the auxiliary capacitance portions 70 according to the first embodiment of the invention. FIG. 6B is an enlarged cross-sectional view showing the auxiliary capacitance portions 71 according to Comparative Example 3 corresponding to FIG. 6A. In description with reference to FIG. 6B, the same elements as those of the first embodiment are denoted by the same reference numerals, and description thereof is simplified or omitted.

When the first embodiment and Comparative Example 3 are compared in terms of auxiliary capacitance portions, in the first embodiment, the second gate-insulating film 51 having a thickness d1 is disposed on the auxiliary capacitance electrode 34x, and in Comparative Example 3, a first gate-insulating film 50 having a thickness d3 (a sum of the thicknesses d1 and d2 of the first and second gate-insulating films 50 and 51 according to the first embodiment) is disposed on the auxiliary capacitance electrode 34x. Namely, in comparison with the first embodiment, in Comparative Example 3, the thickness of the insulating film (first gate-insulating film 50) constituting the auxiliary capacitance Csx as a dielectric material becomes large.

Now, relative magnitudes of the auxiliary capacitance Cs1 according to the first embodiment and the auxiliary capacitance Csx according to Comparative Example 3 are described under suitable dimensions of d1=1000 Å, d2=1000 Å-3000 Å, and d3=2000 Å-4000 Å. In the first embodiment, the auxiliary capacitance Csx=(εᵣ×ε₀×Sz)/1000 can be obtained from Equation 1. In the Comparative Example 3, the auxiliary capacitance Cs1=(εᵣ×ε₀×Sz)/(2000-4000) can be obtained from Equation 1. Therefore, (auxiliary capacitance Cs1) : (auxiliary capacitance Csx)=(2-4):1. Accordingly, in the first embodiment, when the area of the auxiliary capacitance portions 70 is set to the same value as the area Sz of the auxiliary capacitance portions 71 according to Comparative Example 3, it is possible to increase the magnitude of the auxiliary capacitance Cs1 in comparison with Comparative Example 3. Accordingly, in the first embodiment, when the magnitude of the auxiliary capacitance Cs1 is set to the same value as the magnitude of the auxiliary capacitance Csx according to Comparative Example 3, it is possible to decrease the area Sz of the auxiliary capacitance portions 70 by the corresponding amount. In this case, the area Sz of the auxiliary capacitance portions 70 can be set to be (½-¼) times. As a result, in the first embodiment, the area Sz of the auxiliary capacitance portions 70 can be reduced in comparison with Comparative Example 3, so that it is possible to increase the aspect ratio.

In summary, in the liquid crystal apparatus 100, the auxiliary capacitance portion 70 forming the auxiliary capacitance Cs1 is disposed in the regions where the auxiliary capacitance electrode 34x and the pixel electrode 10 overlap each other in a plan view. The auxiliary capacitance portion 70 includes the auxiliary capacitance electrode 34x, the second gate-insulating film 51 disposed on the auxiliary capacitance electrode 34x and having a thickness smaller than the first gate-insulating film 50, and the drain electrode 37 disposed on the second gate-insulating film 51.

Therefore, in the auxiliary capacitance portion 70, the auxiliary capacitance Cs1 using the second gate-insulating film 51 as a dielectric material is formed between the auxiliary capacitance electrode 34x and the drain electrode 37. As described above, since the thickness of the second gate-insulating film 51 is set to be smaller than that of the first gate-insulating film 50, the thickness d in Equation 1, that is, a general electrostatic capacitance equation, can be reduced. As a result, in the auxiliary capacitance portions 70, the magnitude of the auxiliary capacitance C1 can be increased by decreasing the thickness d1 of the second gate-insulating film 51 in Equation 1. Therefore, it is possible to reduce the area Sz of the auxiliary capacitance portions 70 and maintain the predetermined magnitude of the auxiliary capacitance C1 in Equation 1, so that it is possible to improve the aspect ratio. Particularly, when one pixel electrode is constructed with four subpixels, the aspect ratio may be decreased in comparison with Comparative Example 1 where one pixel electrode is constructed with three subpixels. However, due to the aforementioned construction of the first embodiment of the invention, it is possible to prevent a decrease in the aspect ratio of each subpixel.

### Second Embodiment

As described above, the first embodiment of the invention employs the transmissive liquid crystal apparatus 100 having TN (Twisted Nematic) liquid crystals and pixels, each of which includes four-colored regions of colors of colors R, G, B, and C. However, a second embodiment of the invention employs a semi-transmissive semi-reflective liquid crystal apparatus 200 having liquid crystals having negative dielectric anisotropy and pixels, each of which includes four-colored regions of colors R, G, G, and C.

Construction of Pixel

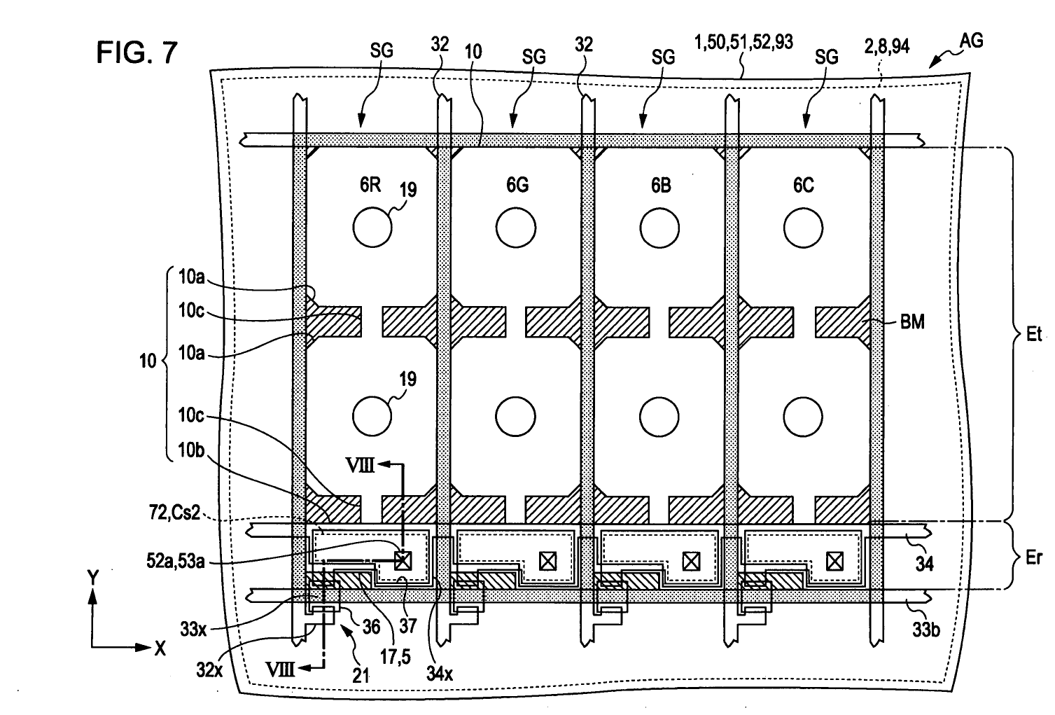

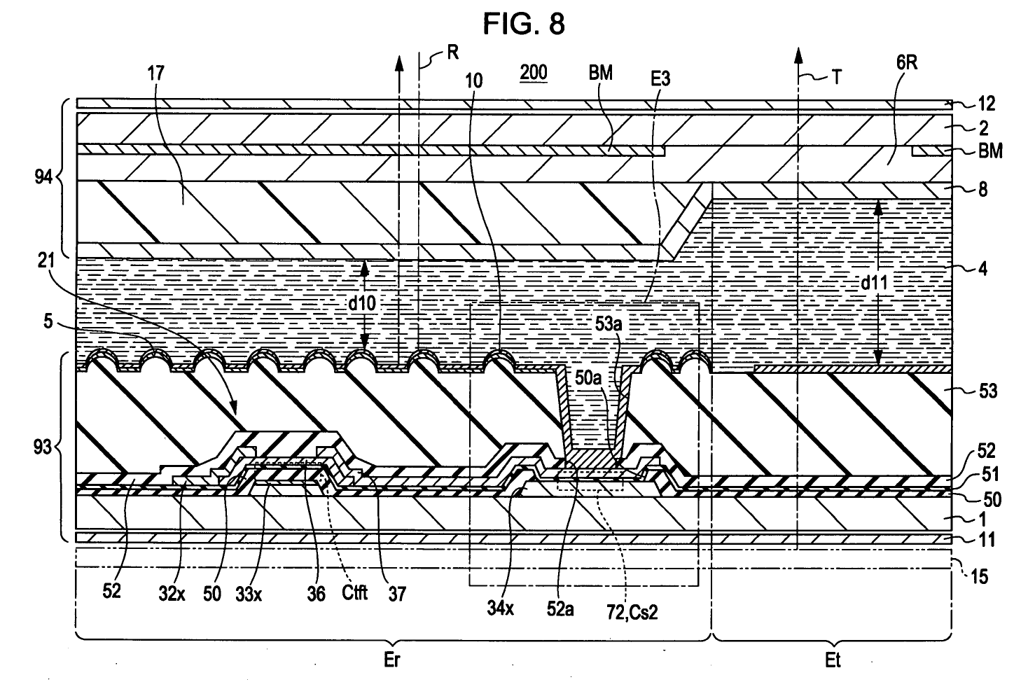

Next, a construction of the pixel according to the second embodiment of the invention is described with reference to FIGS. 7 and 8. Hereinafter, the same elements as those of the first embodiment are denoted by the same reference numerals, and description thereof is simplified or omitted.

FIG. 7 is a partial plan view showing one pixel of the liquid crystal apparatus 200 in a perspective state of the color filter substrate 94 according to the second embodiment as seen from the color filter substrate 94 to the device substrate 93 according to the second embodiment in a plan view. FIG. 8 is a partial cross-sectional view showing one pixel of the liquid crystal apparatus 200 taken along line VIII-VIII of FIG. 7.

Firstly, differences between the construction of the pixel on the device substrate 93 according to the second embodiment and that of the first embodiment are mainly described.

In the second embodiment, a transmitting region Et where a transmissive display mode is performed and a reflecting region Er where a reflecting display mode is performed are disposed in each subpixel region SG constituting one pixel region AG.

An auxiliary capacitance electrode 34x formed with an L-shaped plane is disposed on the inner surface of the lower substrate 1 corresponding to the reflecting region. A second gate-insulating film 51 having a thickness dl same as that of the first embodiment is disposed on the inner surface of the auxiliary capacitance electrode 34x. A portion of a gate electrode 37 is disposed on the inner surface of the second gate-insulating film 51. An auxiliary capacitance Cs2 using the second gate-insulating film 51 as a dielectric material is formed between the auxiliary capacitance electrode 34x and the drain electrode 37. In the specification, a region where the auxiliary capacitance Cs2 is formed is referred to as an auxiliary capacitance portion 72. In such a construction, since the auxiliary capacitance portion 72 is not a non-display region but used as a reflective display region, it is possible to improve the aspect ratio.

In addition, in the reflecting region Er, a plurality of convex-concave portions are formed on the inner surface of an interlayer insulating film 53, and a reflecting film 5 having a reflective property is disposed on an the inner surface of the interlayer insulating film 53. Since a plurality of the convex-concave portions are formed on the interlayer insulating film 53, the reflecting film 5 has a shape similar to the convex-concave portions. Therefore, at the time of driving the liquid crystal, light reflected from the reflecting film 5 can be suitably scattered. In addition, as described later, the reflecting film 5 is electrically connected to the pixel electrode 10 so as to function as a reflecting electrode. In addition, in each subpixel region SG, the pixel electrode 10 are disposed on the inner surface of the reflecting film 5 corresponding to the reflecting region Er and the inner surface of the interlayer insulating film 53 corresponding to the transmitting region Et.

The pixel electrode 10 according to the second embodiment of the invention has the so-called CPA (Continuous Pinwheel Alignment) structure including a plurality (two) of transparent first unit electrode portions 10a having a substantially polygonal planar shape, two transparent second unit electrode portions 10b having a substantially rectangular planar shape, and a plurality (two in the embodiment) of transparent connection electrode portions 10c. In the invention, the pixel electrode suitable for a vertically aligned type is not limited to the construction of the pixel electrode 10 according to the second embodiment.

The first and second unit electrode portions 10a and 10b and the connection electrode portions 10c are formed in a body. Each of the first unit electrode portions 10a is disposed on the inner surface of the interlayer insulating film 53 corresponding to the transmitting region Et in each subpixel region SG. The one of the first unit electrode portions 10a is disposed at a position where the one-side first unit electrode portion 10a is adjacent to the other-side first unit electrode portion 10a in the Y direction, at a position of an upper portion of the paper of FIG. 7, and at a position where the first unit electrode portions 10a do not overlap each other in plan view. The one of the connection electrode portions 10c is disposed between the one-side first unit electrode portion 10a and the other-side first unit electrode portion 10a to connect both of the first unit electrode portions 10a. Each of the second unit electrode portions 10b is disposed on the inner surface of the reflecting layer 5 corresponding to the reflecting region Er in each subpixel region SG. The second unit electrode portion 10b is disposed at a position where the second unit electrode portion 10b is adjacent to the other-sid first unit electrode portion 10a in the Y direction, at a position under the paper of FIG. 7, and at a position where the second unit electrode portion 10b and the first unit electrode portions 10a do not overlap each other in a plan view. The other one of the connection electrode portions 10c is disposed between the other-side first unit electrode portion 10a and the other-side second unit electrode portion 10b to connect both of the first and second unit electrode portions 10a and 10b. In such a construction, the pixel electrode 10 has a planar shape of substantially a chain of droplets as seen in a plan view.

In the vertically aligned type, in order to align the liquid crystal molecules in the radial direction on the first unit electrode portions 10a, the first unit electrode portions 10a are formed to have a polygonal shape, a circular shape, or a shape where an outer circumference portions of the electrode are substantially equally distant from a center thereof. Since a plurality f the first unit electrode portions 10a are disposed in one subpixel electrode region SG, a size of each of the first unit electrode portions 10a can be reduced, so that it is easy to control the alignment of the liquid crystal molecules. Namely, in comparison with a case where a large one first unit electrode portion 10a is disposed in one pixel electrode, it is easy to accurately control the alignment of the liquid crystal molecules. On the other hand, the second unit electrode portions 10b disposed on the reflecting region Er are not formed to have a shape where an outer circumference portions of the electrode are substantially equally distant from a center thereof. Since the reflective display mode is used as an auxiliary display mode, the shape of the second unit electrode portions 10b does not greatly influence the display quality. An alignment film (not shown) which has been subjected to a rubbing process is disposed on the inner surfaces of the interlayer insulating film 53, the pixel electrode 10, and the like. As a result, the pixel including the auxiliary capacitance portion 72 on the device substrate 93 according to the second embodiment is constructed.

Next, differences between the construction of the color filter substrate 94 corresponding to the aforementioned construction of the pixel on the device substrate 93 and that of the first embodiment are mainly described.

A multi-gap layer 17 made of an acrylic resin or other transparent insulating materials are disposed on the inner surface of a colored layer 6C corresponding to the reflecting region Er. A common electrode 8 is disposed on the inner surface of the multi-gap layer 17 corresponding to the reflecting region Er and the inner surface of a colored layer 6R corresponding to the transmitting region Et.

As shown in FIG. 7, protrusions 19 made of a transparent insulating resin material are formed substantially at centers of the first unit electrode portions 10a on the inner surface of the common electrode 8 corresponding to the transmitting region Et. In the invention, instead of the protrusions 19, openings may be formed. Due to the protrusions (or openings) formed on the inner surface of the common electrode 8, it is possible to control tilt angles of the liquid crystal molecules showing a vertical alignment in an initial alignment state. When a voltage is applied across the device substrate 93 and the color filter substrate 94, an electric field in each region of the first unit electrode portion 10a is controlled due to an interaction between the protrusion (or opening) and the first unit electrode portion 10a, so that a region where the liquid crystal molecules are aligned in a radial shape is formed. In the liquid crystal apparatus 200 having such a construction according to the second embodiment, a dependency on a viewing angle is suppressed, so that it is possible to obtain a wide viewing angle. An alignment film (not shown) which has been subjected to a rubbing process is disposed on the inner surfaces of the protrusions 19 and the common electrode 8. As a result, the color filter substrate 94 according to the second embodiment corresponding to the construction of the pixel of the device substrate 93 is constructed.

In such a construction, the device substrate 93 and the color filter substrate 94 are disposed to face each other with the sealing member (not shown) interposed therebetween, and the liquid crystal layer 4 is formed by sealing the liquid crystals having negative dielectric anisotropy between the two substrates. In the liquid crystal apparatus 200, spacers (not shown) are provided between the adjacent pixels on the inner surface of the multi-gap layer 17. Therefore, the thickness of the liquid crystal layer 4 corresponding to the reflecting region Er is set to d10, and the thickness of the liquid crystal layer 4 corresponding to the transmitting region Et is set to d11 (>d10), so that the so-called multi-gap structure is obtained. As a result, it is possible to optimize optical characteristics in the reflective and transmissive display modes.

In the transmissive display mode performed by the liquid crystal apparatus 200 having such a construction, the illumination light emitted from the backlight 15 propagates along a path T shown in FIG. 8 and passes through the first unit electrode portions 10a, the connection electrode portions 10c, and the colored layers 6R, 6G, 6B, and 6C to reach the observer. When the illumination light passes the colored layers 6R, 6G, 6B, and 6C, the light can obtain predetermined colors and brightnesses. As a result, a desired color image can be seen by the observer. On the other hand, in the reflective mode, external light incident on the liquid crystal apparatus 200 propagates along a path R shown in FIG. 8. The external light incident on the liquid crystal apparatus 200 is reflected by the reflecting film 5 disposed on the reflecting region Er, so that the external light can reach the observer. In this mode, the external light passes through regions where the second unit electrode portion 10b and each of the colored layers 6 of colors R, G, B, and C and is reflected by the reflecting layer 5 disposed under each of the colored layers 6. The external light passes through each of the colored layers 6 again, so that the light can obtain predetermined colors and brightnesses. As a result, a desired color image can be seen by the observer. Particularly, similar to the first embodiment, since the liquid crystal apparatus 200 is constructed to use the complementary color C as well as the primary colors R, G, and B, it is possible to suppress a decrease in brightness of green light G to which human eyes are highly sensitive. In addition, in terms of the later-described CIE (Commission Internationale de l'Eclairage) x-y chromaticity diagram, in comparison with a liquid crystal apparatus using three colors R, G, and B, a color reproducible range (chromaticity range) can be widened, so that it is possible to implement a high color rendering display.

According to the second embodiment, since the auxiliary capacitance portion 72 has substantially the same construction as that of the auxiliary capacitance portion 70 according to the first embodiment, it is possible to obtain the same advantages as those of the first embodiment. In addition, according to the second embodiment, since the area of the reflecting region Er is arranged according to the area of the auxiliary capacitance portion 72, the area of the reflecting region Er where the auxiliary capacitance portion 72 is disposed is set to be small, and the area of the transmitting region Et is set to be large, so that the transmissive display mode is constructed to be dominated. In addition, according to the second embodiment, even in a case where the aspect ratio may be reduced due to small area of the pixel electrode 10, the area of the auxiliary capacitance portion 72 can be reduced by employing the invention, so that it is possible to greatly improve the aspect ratio.

### Other Embodiments

In the aforementioned embodiments, the four colored regions corresponding to four colors of R, G, B, and C are exemplified. However, the invention is not limited thereto, but one pixel may be constructed with four colored regions corresponding to other four colors.

The four colored regions which are in a visible range (380 nm-780 nm) in which a color of light varies with a wavelength include a blue-based region (referred to a first colored region), a red-based region (referred to a second colored region), and two colored regions (referred to third and fourth colored regions) of which colors are selected from the color range of blue to yellow. Here, the term “-based” dose not mean only a pure color. For example, “blue-based” is not limited to pure blue, but it may include bluish red, bluish green, or the like. Similarly, “red-based” is not limited to pure red, but it may include orange. The colored region may be constructed with a single colored layer. Alternatively, the colored region may be constructed by overlapping a plurality of different colored layers. In addition, although the aforementioned colored regions are based on hues of colors, the colors may be set by suitably adjusting chroma or luminosity.

The detailed color ranges are as follows.
The blue-based region has the color range of bluish red to bluish green, more preferably, from deep blue to blue.
The red-based region has the color range of orange to red.
The one of the two colored regions of which colors are selected from the color range of blue to yellow has the color range of blue to green, more preferably, from bluish green to green.
The other of the two colored regions of which colors are selected from the color range of blue to yellow has the color range of green to orange, more preferably, from green to yellow, or from green to yellowish green.

The colored regions do not use the same color. For example, if a green-based color is used for the two colored regions of which colors are selected from the color range of blue to yellow, green may be used for the one, and a blue-based color or a yellowish-green-based color may be used for the other.

As a result, it is possible to implement wider color reproducibility than that of the well-known RGB colored regions.

As a detailed example, the colored regions can be represented by wavelength of light as follows.
The blue-based region is a colored region of which the peak wavelength of light passing through the color region is in the wavelength range of 415 nm to 500 nm, more preferably, from 435 nm to 485 nm.
The red-based region is a colored region of which the peak wavelength of light passing through the color region is 600 nm or more, more preferably, 605 nm or more.
The one of the two colored regions of which colors are selected from the color range of blue to yellow is a colored region of which the peak wavelength of light passing through the color region is in the wavelength range of 485 nm to 535, more preferably, from 495 nm to 520 nm.
The other of the two colored regions of which colors are selected from the color range of blue to yellow is a colored region of which the peak wavelength of light passing through the color region is in the wavelength range of 500 nm to 590, more preferably, from 510 nm to 585 nm or from 530 nm to 565 nm.

In the transmissive display mode, these values of wavelengths are obtained when the illumination light emitted from the backlight 15, that is, an illumination unit passes through the color filters (colored layers). In the reflective display mode, these values of wavelengths are obtained when the external light is reflected. As another detailed example, the colored regions can be represented by the x-y chromaticity diagram as follows.
The blue-based region is a colored region in x≦0.151 and y≦0.200, more preferably, in 0.134≦x≦0.151 and 0.034≦y≦0.200.
The red-based region is a colored region in x0.520≦x and y≦0.360, more preferably, in 0.550≦x≦0.690 and 0.210y≦0.360.
The one of the two colored regions of which colors are selected from the color range of blue to yellow is a colored region in x≦0.200 and 0.210≦y, more preferably, in 0.080≦x≦0.200 and 0.210≦y≦0.759.
The other of the two colored regions of which colors are selected from the color range of blue to yellow is a colored region in 0.257≦x and 0.450≦y, more preferably, in 0.257≦x≦0.520 and 0.450≦y≦0.720.

In the transmissive display mode, these values of the x-y chromaticity diagram are obtained when the illumination light emitted from the backlight 15, that is, an illumination unit passes through the color filters (colored layers). In the reflective display mode, these values of the x-y chromaticity diagram are obtained when the external light is reflected.

In a case where transmissive and reflective regions are disposed one subpixel region SG, these four colored regions having the aforementioned ranges can be used for the transmissive and reflective regions.

RGB light sources such as an LED (Lighting Emitting Diode), a fluorescent light tube, and an organic EL (organic electroluminescence) may be used for the backlight 15. Alternatively, a white light source may be used. In addition, the white light source may be generated from a blue light emitting material or a YAG fluorescent material.

Preferred RGB light sources are as follows.
The B light source is a source of which a the peak wavelength of emitted light is in the wavelength range of 435 nm to 485 nm.
The G light source is a source of which a the peak wavelength of emitted light is in the wavelength range of 520 nm to 545 nm.
The R light source is a source of which a the peak wavelength of emitted light is in the wavelength range of 610 nm to 650 nm. When the colored layers are selected based on the wavelengths of the RGB light sources, it is possible to implement wider color reproducibility. In addition, a light source having a plurality of wavelength peaks, for example, 450 nm and 560 nm may be used.

As a detailed example, the four colored regions are as follows.
Red, blue, green, and cyan (bluish green) colored regions (examples of the aforementioned embodiments)
Red, blue, green, and yellow colored regions
Red, blue, deep green, and yellow colored regions
Red, blue, emerald, and yellow colored regions
Red, blue, deep green, and yellowish green regions
Red, bluish green, deep green, and yellowish green regions
   Modifications

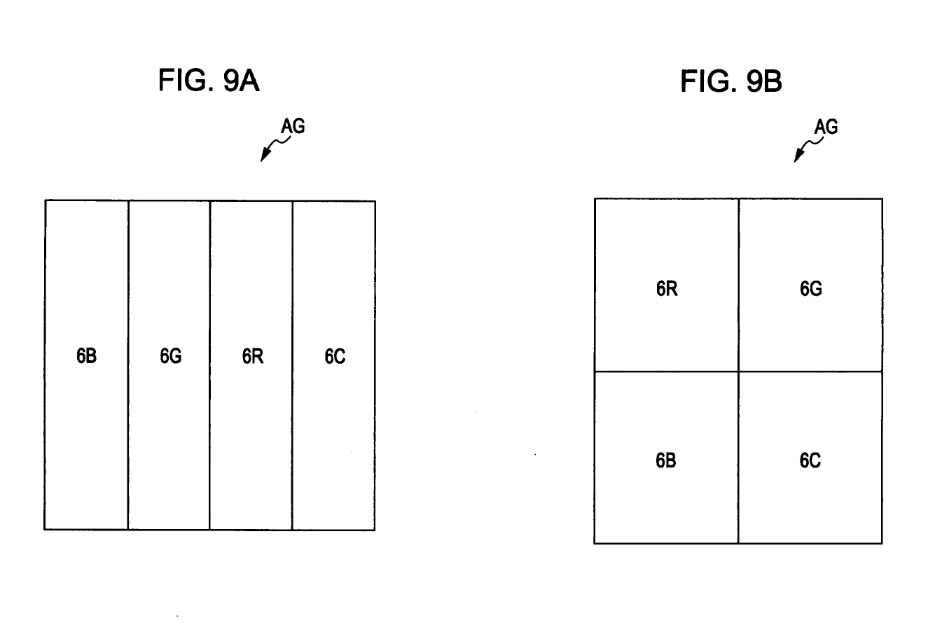

In the aforementioned embodiments, the colored layers 6 are arrayed in a shape of stripe in the array order of the colors R, G, B, and C in each pixel region AG. However, the invention is not limited to a specific array order. For example, as shown in FIG. 9A, the colored layers 6 are arrayed in a shape of stripe in the array order of the colors B, G, R, and C. Alternatively, in the invention, as shown in FIG. 9B, the colored layers 6 corresponding to the colors R, G, C, and B are arrayed in a checkered shape or a mosaic shape in each pixel region AG.

In addition, in aforementioned embodiments, the invention is employed by a transmissive liquid crystal apparatus or a semi-transmissive semi-reflective liquid crystal apparatus. However, the invention is not limited thereto, but it may be employed by a reflective liquid crystal apparatus.

The invention is not limited to the aforementioned embodiments and modifications, but various changes in form may be made without departing from the scope and spirit of the invention.

Electronic Apparatus

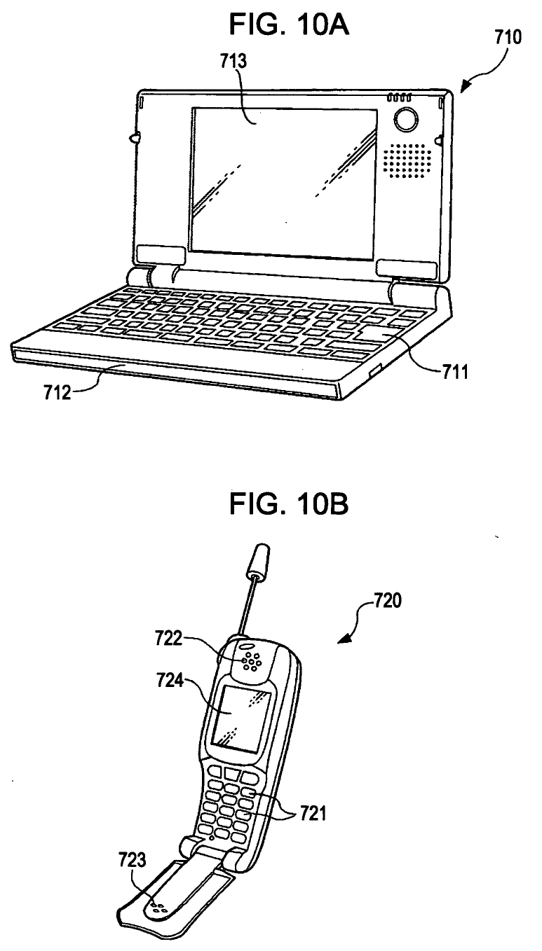

Next, detailed examples of an electronic apparatus capable of employing the liquid crystal apparatus 100 or 200 according to the aforementioned embodiments are described with reference to FIG. 10.

Firstly, an example of a portable personal computer (so-called a notebook computer) using the liquid crystal apparatus 100 or 200 according to the aforementioned embodiments is described. FIG. 10A is a perspective view showing a construction of the personal computer. As shown in the figure, the personal computer 710 includes a main body 712 provided with a keyboard 711 and a display unit 713 employing the liquid crystal apparatus 100 or the like according to the invention.

Next, an example of a mobile phone using the liquid crystal apparatus 100 or 200 according to the aforementioned embodiments is described. FIG. 10B is a perspective view showing a construction of the mobile phone. As shown in the figure, the mobile phone 720 includes a plurality of manipulation buttons 721, an earpiece 722, a mouthpiece 723, and a display unit 724 employing the liquid crystal apparatus 100 or the like according to the invention.

In addition to the personal computer shown in FIG. 10A and the mobile phone shown in FIG. 10B, as an electronic apparatus employing the liquid crystal apparatus 100 or 200 according to the aforementioned embodiments, there are a liquid crystal television set, a view finder type monitor, a direct-view type video tape recorder, a car navigation system, a pager, an electronic scheduler, a calculator, a word processor, a workstation, a video telephone, a POS terminal, a digital still camera, and the like.

The entire disclosure of Japanese Patent Application No. 2005-331389, filed Nov. 16, 2005 is expressly incorporated by reference herein.

What is claimed is:

1. An electro-optical apparatus comprising:
a plurality of pixels, each pixel including four subpixels or more;
a gate-insulating layer having a two-layered structure; and
auxiliary capacitance formed in one of the layers of the gate-insulating layer.

2. An electro-optical apparatus comprising:
a plurality of pixels, each pixel including four subpixels or more;
first and second wire lines which extend to intersect each other;
auxiliary capacitance lines disposed between two adjacent second wire lines;
thin-film transistors which are disposed at positions corresponding to intersections of the first and second wire lines, each thin-film transistor including a gate electrode portion constituted by a portion of the second wire line, a first insulating layer disposed on the gate electrode portion and constituted by the gate-insulating layer, a second insulating layer disposed on the first insulating layer, having a smaller thickness than the first insulating layer, and constituted by the gate-insulating layer, a drain electrode portion disposed on the second insulating layer, and a source electrode portion disposed on the second insulating layer and constituted by a portion of the first wire line;
a substrate having pixel electrodes electrically connected to the drain electrode portions; and
auxiliary capacitance portions disposed at positions where the auxiliary capacitance lines and the pixels overlaps each other in a plan view to form auxiliary capacitance,
wherein each of the auxiliary capacitance portions includes an auxiliary capacitance electrode portion constituted by a portion of the auxiliary capacitance line, the second insulating layer disposed on the auxiliary capacitance electrode portion, and the drain electrode portion disposed on the second insulating layer, and
wherein at least a portion of the auxiliary capacitance portion does not overlap the first insulating layer.

3. The electro-optical apparatus according to claim 2, wherein the thickness of the first insulating layer is in the range of 2000 Å to 4000 Å, and the thickness of the second insulating layer is in the range of 500 Å to 1500 Å.

4. The electro-optical apparatus according to claim 2,
wherein an interlayer insulating film is disposed between the pixel electrode and the drain electrode portion,
wherein a contact hole is disposed at a portion of the interlayer insulating film where the auxiliary capacitance portion is located, and
wherein the pixel electrode is electrically connected to the drain electrode portion through the contact hole.

5. The electro-optical apparatus according to claim 4, wherein the auxiliary capacitance lines are made of a conductive material having a light-shielding property.

6. The electro-optical apparatus according to claim 1,
wherein each of the subpixels has a transmitting region, a reflecting region, or both transmitting and reflecting regions,
wherein a reflecting film is disposed at a position corresponding to the reflecting region, and
wherein each of the pixels includes four subpixels.

7. The electro-optical apparatus according to claim 6,
wherein the auxiliary capacitance portion is provided in the reflecting region,
wherein the reflecting film is disposed on the interlayer insulating film, and
wherein the auxiliary capacitance portion and the reflecting film overlap each other in a plan view.

8. The electro-optical apparatus according to claim 6, further comprising a substrate which includes an electro-optical layer having negative dielectric anisotropy,
wherein the pixel electrode includes a plurality of polygonal or circular unit electrode portions, and
wherein colored regions which are in a visible range in which the color of light varies with wavelength and which are provided to positions corresponding to the subpixels include a blue-based region, a red-based region, and two colored regions of which colors are selected from the color range of blue to yellow.

9. The electro-optical apparatus according to claim 8,
wherein the blue-based region has the color range of bluish red to bluish green,
wherein the red-based region has the color range of orange to red, and
wherein the one of the two colored regions of which colors are selected from the color range of blue to yellow has the color range of blue to green, and the other colored region has the color range of green to orange.

10. The electro-optical apparatus according to claim 8,
wherein in a CIE chromaticity diagram, the blue-based region is a colored region satisfying the relation of x≦0.151 and y≦0.200,
wherein the red-based region is a colored region satisfying the relation of 0.520≦x and y≦0.360, and
wherein the one of the two colored regions of which colors are selected from the color range of blue to yellow is a colored region satisfying the relation of x≦0.200 and 0.210≦y, and the other colored region is a colored region satisfying the relation of 0.257≦x and 0.450≦y.

11. The electro-optical apparatus according to claim 8, wherein the colored region which are provided to positions corresponding to the subpixels include a first colored region of which the peak wavelength of light passing through the first color region is in the range of 415 nm to 500 nm, a second colored region of which the peak wavelength of light passing through the second color region is 600 nm or more, a third colored region of which the peak wavelength of light passing through the third color region is in the range of 485 nm to 535 nm, and a fourth colored region of which the peak wavelength of light passing through the fourth color region is in the range of 500 nm to 590 nm.

12. An electronic apparatus including the electro-optical apparatus according to claim 1.
